(19) United States
(12) Patent Application Publication
(10) Pub. No.: US 2009/0232628 A1
(43) Pub. Date: Sep. 17, 2009

(54) Apparatus for mounting a motorcycle on a carrier

(76) Inventor: Robert Miller, Huntington Beach, CA (US)

Correspondence Address: I. Michael Bak-Boychuk;Attorney at Law, P.O. Box 32501, Long Beach, CA, 90832, US

(21) Appl. No.: 12/231,267

(22) Filed: Sep. 2, 2008

Related U.S. Application Data
(60) Provisional application No. 61/069,106, filed on Mar. 12, 2008.

(51) Int. Cl. B60P 3/077

(52) U.S. Cl. 414/462

(57) ABSTRACT

A capturing mechanism useful to retain a motorcycle on a variously inclined ramp includes an over-center spring loaded mechanism that is a self-triggered to deploy a hinged restraint compressing a motorcycle wheel against a conforming slip by the rolling translation thereof towards the forward end of the deployed ramp. Once thus temporarily fixed to the ramp the motorcycle and the ramp are then lifted onto the transport vehicle and then further restrained for transport by a rear bracket. At the destination the ramp, with the motorcycle fixed thereon, is lowered to the ground again and a detachable lever is then useful to fully release the spring loaded restraint.

### REFERENCE TO RELATED APPLICATIONS

This application obtains the benefit of the earlier filing date of U.S. Provisional Application Ser. No. 61/069,106 filed on Mar. 12, 2008.

### BACKGROUND OF THE INVENTION

1. Field of the Invention

The present invention relates to motorcycle carrier mechanisms, and more particularly to retainer structures useful with articulated carriers that in one alignment form a ramp along which a motorcycle is rolled to be then lifted into or onto a vehicle.

2. Description of the Prior Art

Articulated motorcycle carriers have been known in the past, most often taking the form of a deployable ramp to which a motorcycle is secured and thereafter lifted onto the carrying bed of a motor vehicle. Examples of such carriers may be found in the teachings of U.S. Pat. No. 6,698,994 issued to Barrett; U.S. Pat. No. 6,524,056 issued to Kloster; U.S. Pat. No. 6,634,849 issued to Clary; and also the teachings in U.S. Pat. No. 4,932,829 earlier issued to the present inventor. In each instance the motorcycle is rolled onto the deployed ramp, either manually or by its by its own power, and then just provisionally secured or manually held as the ramp is lifted onto the vehicle.

While suitable for the purposes intended, the foregoing technique entails restraint limitations that sometime may exceed the strength of the provisional securement and/or the strength levels of the person providing the manual restraint. Those in the art will appreciate that the current motor purchasing consumer trends favor large displacement and therefore quite heavy motorcycles that are particularly suited for high speed highway use. Of course, the loading incidents of these same heavy motorcycles are therefore often right on the side of a roads, very often in locations that rarely provide the necessary level ground and wide separation from the moving traffic that one would desire. Simply, the usual loading conditions of a large displacement motorcycle are not always ideal.

In the past various mechanisms have been proposed which in one way or another restrain the front wheel of the motorcycle wheels to the deployed ramp. Most often these prior art securement mechanisms entail separate tie-down structures that are attached to the ramp after the motorcycle is positioned thereon and therefore entail a two-man operation since the motorcycle needs to be held vertically on the inclined ramp as the securing mechanism is being attached. Alternatively, the ramp is implemented with complex mechanisms like those shown in U.S. Pat. No. 7,150,359 to Lyons et al., and similarly in U.S. Pat. No. 4,437,597 to Doyle, in which pivoted brackets are selectively released to capture the front wheel of the motorcycle once it is brought home.

While again suitable for the purposes intended, mechanisms of this nature lack the alignment range needed to allow the motorcycle that is being mounted onto a ramp inclined to rest on a sloping roadside while the motorcycle is vertically maintained. Simply, the foregoing restraint structures form a part of the ramp and their pivotal deployable capturing fixture is typically is conformed to match the particular tire width and diameter as it is pivoted about a transverse pivot axis spanning the ramp into a restraining alignment that is limited to the range of the tire widths and diameters that a given clamping mechanism can accept.

A third class of structures, utilizing various triggered mechanisms to capture a wheel of a motorcycle as it is rolled on a ramp, like the pivotal restraint mechanism exemplified in U.S. Pat. No. 3,542,157 to Noah, while quite effective in a one-man setting to function as a wheel chock, lacks the necessary lateral restraints needed to keep the motorcycle upright at the various terrain inclinations on which the loading process is often carried out. Thus while effective for the purposes intended this third group of restraints needs substantial augmentation to achieve the usefulness dictated by the currently favored motorcycle dimensions.

Simply, the majority of the current motorcycle stands rely (a) on a U-shaped front wheel receiving slip combined with (b) a pivotally mounted U-shaped section that will pivot up behind the front tire using the weight of the motorcycle. Thus in order to move the motorcycle out of this clamping combination the front wheel load needs to be lifted by the handlebars, unloading the pivoting U-shaped section so that it can pivot backwards. Accordingly, while suitable for the purposes intended the height and weight of the motorcycles currently enjoyed by the riding public render this task difficult by a user of average size and musculature.

The alternatives, as exemplified by the teachings of U.S. Pat. No. 7,150,359 to Lyons et al, require that the user stand at the front side of the motorcycle to hold it in a vertical alignment by the handlebars while articulating the clamping mechanisms to overcome the engagement interlocks which, when released, may allow the motorcycle to roll down the ramp or to tip over. Again, while suitable for its purposes the currently large motorcycles may overwhelm the operator during disengagement, possibly causing full loss of control.

One, of course, will appreciate that the most optimal position relative a motorcycle is one where the user sits astride thereon. A self-triggered restraining structure that conveniently secures the motorcycle to the ramp for subsequent loading when deployed on variously aligned local terrain inclinations and that is conveniently released with the user astride thereon is therefore extensively desired and it is one such structure that is disclosed herein.

### SUMMARY OF THE INVENTION

Accordingly, it is the general purpose and object of the present invention to provide a securement mechanism deployed on a loading ramp that is triggered to capture the wheel of a motorcycle at various inclinations as it is rolled on the ramp.

Other objects of the invention are to provide an over-center triggered securing mechanism on the end of a motorcycle loading ramp for securing the front wheel thereto.

Further objects of the invention are to provide a securing mechanism on the end of a motorcycle loading ramp triggered to secure the front wheel at various inclinations to allow the further securing of the motorcycle.

Yet additional objects of the invention are to provide a self-triggered retention mechanism for securing the front wheel of a motorcycle to a loading ramp in order to allow the further securing of the rear wheel.

Briefly, these and other objects are accomplished within the present invention by mounting on the forward end of a motorcycle ramp an over-center mechanism tripped as the front wheel of a motorcycle is rolled thereover to release a spring loaded strut from its latched, pre-loaded state. In the course of this release the expanding strut then drives a transverse roller against the rear surface of the wheel, thus capturing the wheel within a front restraining slip.

More precisely, the over-center mechanism comprises generally a pivotally articulating plate mounted over a fulcrum formed by a transverse pivot spanning across the ramp, the plate further providing the limits of pivotal motion of a rectangular frame straddling the plate from the same fulcrum. A transverse roller mounted at the free edge of the frame is thus free to articulate above the plate in an arc centered at the fulcrum axis in response to the extension of an actuator rod extending from a gas pressurized or a spring biased strut having its other end engaged to a stop releasably fixed to the ramp rearward of the plate.

When pivoted rearwards the frame alters the spacing between the stop and the transverse roller at its free edge to compress the strut and when the strut axis is carried by this pivotal arc to a point where it passes below the fulcrum the frame, and the plate below it, are then trapped against the ramp bottom surface in an over-center engagement. This pre-loaded and trapped engagement is achieved with the use of a removable lever that engages the frame to provide the necessary mechanical advantage to set the inventive mechanism to its over-center alignment.

In this trapped and compressed form the over-center mechanism is aligned within the ramp to receive the motorcycle and once its front wheel progresses beyond the pivot axis of the plate the over-center interlock within the ramp is released, with the roller on the free edge of the frame then advanced by the expanding strut to drive the wheel against a front retaining slip mounted on the ramp. It will be appreciated that the foregoing release of the pre-loaded spring activated assembly is effected automatically as the motorcycle is advanced along the ramp, thus allowing the rider to remain seated thereon. Since a heavy motorcycle is usually kept close to vertical by a rider, the capture of the wheel between the roller and the opposed slip, and thus the retention of the motorcycle, is also vertical regardless of the various lateral inclinations of the ramp that may be caused by local terrain undulations.

Thus the forward movement of the front motorcycle tire over the pivoted plate unlatches the pre-loaded mechanism that was set earlier allowing the roller, once lifted above the rear plate edge, to force the wheel forward to temporarily capture and stabilize the motorcycle. Once thus restrained the user is free to deploy other securing structures including a rear wheel capturing fixture engaged to the rear end of the ramp to fully restrain and fix the motorcycle on the ramp as it is lifted onto the vehicle. Once there, the motorcycle may be finally secured for transport by tightening various adjustment brackets after the transport vehicle is brought to a generally level surface.

Of course, once transported to its destination the ramp with the motorcycle thereon may be lowered to the ground at which point the rear capturing fixture is removed by the user while the motorcycle is still held vertically on the ramp by the front wheel restraint. The user can then install a cantilevered extension into the rear retention mechanism at the other end of the strut and once mounted on the motorcycle unlatch with his foot its engagement, thus removing all confined loading to release the front wheel. The motorcycle, with the rider seated thereon, is thus free to move off the ramp until it returns to the ramp at which point the removable lever engageable to the pivotal frame can then be used again to re-latch the over-center assembly for the next motorcycle loading sequence, and so on. In this manner the inventive over-center mechanism remains safely unloaded until the time of its next use, obtaining the desired safety and also the convenience of unassisted vehicle transport.

### BRIEF DESCRIPTION OF THE DRAWINGS

FIG. 1 is a perspective illustration of the inventive self-triggered retaining structure useful in securing the front wheel of a motorcycle to an articulated ramp in the course of loading thereof for transport on a vehicle;

FIG. 2 is a further perspective illustration of the inventive mounting structure illustrated in FIG. 1 in its triggered deployment compressing the front motorcycle wheel against its slip;

FIG. 3 is yet another perspective detail illustrating an inventive rear wheel restraining fixture provided with adjustable attachment connections to the articulated ramp for securing the motorcycle for transport; and

FIG. 4 is a diagrammatic illustration of the spring loaded strut in the pre-loaded and unlatched extensions thereof corresponding to the several states of the inventive over-center mechanism.

### DESCRIPTION OF THE PREFERRED EMBODIMENT

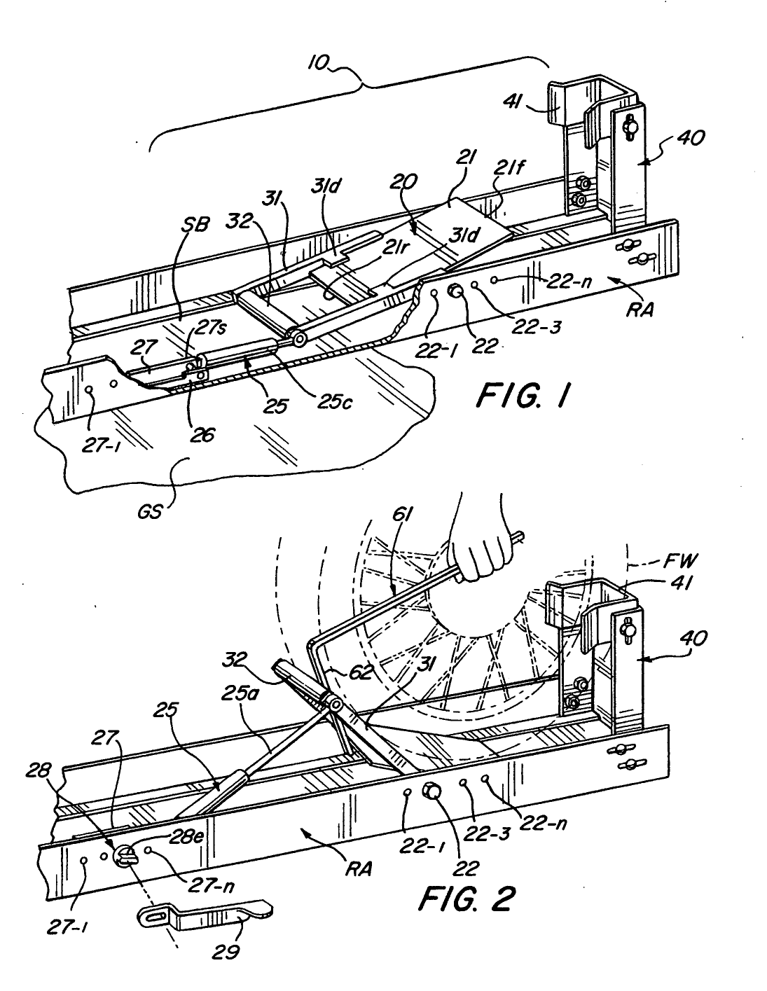

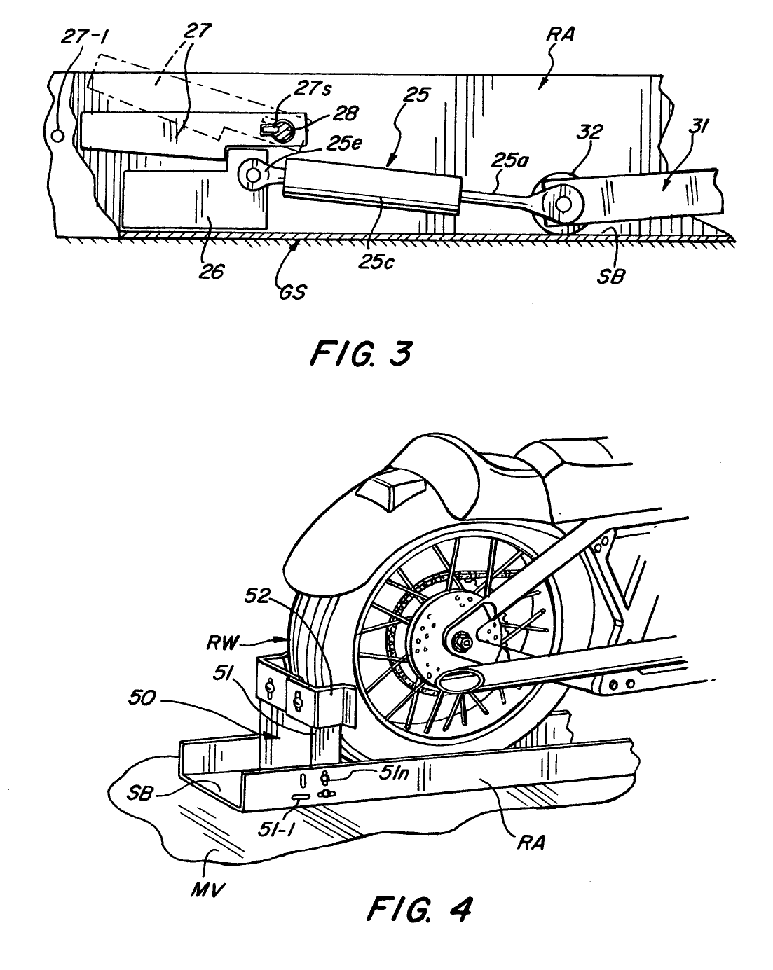

As shown in FIGS. 1 through 4 the inventive mounting structure, generally designated by the numeral 10, comprises a spring loaded over-center mechanism 20 deployed at the front end of a C-sectioned ramp RA conformed for articulation in various known manners, including that earlier described by me in U.S. Pat. No. 4,932,829, to load a motorcycle MC mounted thereon onto or into a motor vehicle MV. A further restraining fixture 50 proximate the other end of the ramp RA is then useful to restrain the rear wheel RW of motorcycle MC on the ramp RA once it is rolled onto the ramp to drive its front wheel FW onto the over-center mechanism 20, releasing the mechanism from its pre-loaded state to capture and restrain the front wheel against a vertically deployed front retaining slip 40. As will be shown below this automatically triggered release allows a single person to load and restrain the motorcycle MC on the ramp at variously angled local ground surfaces GS inclinations.

To effect this initial securement the forwardly deployed over-center mechanism 20 includes a pivoted plate 21 mounted above a transverse pivot formed by a bolt 22 spanning across ramp RA through a selected one of a set of bolt holes 22-1-22-n spaced along the length of the ramp above its base surface SB. Thus pivotally engaged the pivotal plate 21 is free to swing about the pivot between the limits where either its forward edge 21f or its rear edge 21r makes contact with, and is thus opposed by, the base surface SB.

In addition, a generally rectangular frame 31 straddles plate 21 from the pivot bolt 22, carrying in the course of this pivotal motion a transverse roller 32 at its free edge in a pivotal arc that is radially greater than the dimensions of plate 21. This pivotal movement of frame 31 relative plate 21, in turn, is limited by a set of detents 31d on the frame that project inwardly to oppose the plate at both ends of its pivotal movement, thus obtaining a moment transfer from plate 21 to the frame upon the articulation of the plate by the front wheel FW of the motorcycle MC as it is moved along the ramp RA. It is this moment transfer that is then utilized to unlatch an over-center interlock in which a spring loaded strut assembly 25 having its actuator rod 25a pinned to frame 31 adjacent roller 32 and its other end 25e releasably engaged to a stop 27 that are geometrically captured in compression against the bottom surface SB.

Those skilled in the art will appreciate this compressed geometry can be adapted to variously sized motorcycle configurations by a coordinated selection of one of a set of fastener holes 27-1 through 27-n in the wall of ramp RA through which a keyed fastener pin 28 is inserted into a conforming slot 27 in the stop 27 to engage the stop to the ramp together with the pivot location of plate 21 through one of the bolt holes 22-1-22-n. In this manner wheel geometries of various sizes can be conveniently accommodated by the selection of the spacing between the front slip 40, the plate 21 pivot axis defined by the selected bolt hole 22-1 through 22-n and the compressed and trapped dimension of strut assembly 25 determined by the selection of the fastening hole 27-1 through 27-n. A flat projection 28e on the exposed end of pin 28 can then be selectively engaged by a cantilevered extension 29 deployed along the ramp to be articulated by the rider's foot once astride on the motorcycle to pivot stop 27 away from the block 26, thus releasing the pre-load of the strut for unloading.

Those skilled in the art will further appreciate that the fully open geometry of frame 31 relative plate 21 is achieved only when the opposing dimension of the strut assembly 25 is compressed sufficiently to fit between the fully extended deployment of the transverse roller 32 and the selected location of stop 27. To insure a latched state in this opened arrangement it is necessary that the force axis of the compressed strut assembly 25, and therefore its actuating end 25a at the roller 32, extend below the pivot axis of plate 21. This geometric constraints is conveniently achieved by selecting the transverse height of detents 31d to allow the alignment of the roller 32 to be equal or greater than the radius of the cylinder 25c of the actuator assembly 25, to provide geometric clearance. At the same time the height of stop 27 needs to be spaced above the bottom surface SB by a dimension sufficient to allow the passage of the releasable detent block 26 engaed to the end 25e of strut assembly 25 when the cantilevered extension 29 is articulated to pivot the stop and thus release it from its pre-engaged interlocked state.

In this form the inventive over-center assembly 20 can be transported with the strut assembly 25 left unloaded, a state obtained by disengaging the engagement block 26 from the stop assembly 27. When loading is contemplated, however, block 26 is engaged to stop 27, thus fixing end 25e of the strut assembly to the ramp RA with the fully extended dimension of actuator end 25a then accommodated by the pivotal movement of frame 31 to a position against the bottom surface SB thus capturing the plate 21.

To obtain the force multiplications needed to compress the strut assembly a short projection 62 of a portable L-shaped lever 61 can be fitted between the roller 32 and the rear edge 21r of plate 21 and by applying manual force to its longer arm 63 sufficient torque is then be produced to fully articulate the frame 31, bringing the roller 32 into contact with the ramp surface to trap plate 21 which then concurrently compresses the now captive strut assembly 25 which, of course, also aligns its force vector along the base surface SB. Since these previously described dimensional relationships fix this force vector below the vertical spacing of the pivot axis through one of the bolt holes 22-1 through 22-n the over-center mechanism is thus latched and ready for the receipt of the front wheel FW as the motorcycle MC is rolled along ramp RA.

As the front wheel FW rolls onto plate 21 and then over its forward edge 21f its weight then creates a moment bias lifting the rear edge 21r lifting frame 31 through the opposing engagement of detents 31d and once the height of the roller 32 lifts the force vector of the compressed strut assembly 25 above the height of the pivot axis of plate 21 the remaining unrestrained pivotal swing of frame 31 then raises the roller 32 against the rear surfaces of wheel FW with the remaining spring bias in the strut then driving the wheel into slip 40. The front wheel FW is thus captured and retained between roller 32 and the receiving bracket 41 on the upper end of slip 40, stabilizing the motorcycle MC sufficiently to allow the rider to dismount.

Having thus stabilized the motorcycle on the lowered ramp, the rider can then affix the further rear fixture or bracket assembly 50 to the ramp RA, restraining the rear wheel RW. Once again, one of a plurality of pivot holes 51-1 through 51-m extending across the ramp RA may be selected to conform to the motorcycle dimensions to pin the lower end of a vertical brace 51 which at its upper end carries an adjustably secured U-shaped bracket 52 that captures the rear wheel. Once thus secured the ramp with the motorcycle thereon can be raised onto the bed of the vehicle MV and then driven to a generally horizontal site where further adjustments can be effected to fully secure the motorcycle for transport.

Upon arrival the same cantilevered extension 29 can be used to disengage block 26 from stop 27 in the manner previously described, releasing the spring bias against the roller 32 so that it falls back to its open state while the motorcycle is rolled rearwardly off the ramp. In this manner a generally safe retaining mechanism is obtained that is not triggered by each incidental jolt while providing a convenient loading process of the motorcycle.

Obviously many modifications and variations of the instant invention can be effected without departing from the spirit of the teachings herein. It is therefore intended that the scope of the invention be determined solely by the claims appended hereto.

It is claimed:

1. Apparatus for restraining a motorcycle on an articulated ramp deployed from a carrier vehicle when extended to rest on the local ground surface, comprising:
a front retaining bracket mounted generally orthogonally to the forward end of said ramp to deploy an elevated receiving slip conformed to engage the forward wheel of said motorcycle;
an elongate plate mounted on a transverse pivot extending across said ramp proximate said front retaining bracket for pivotal articulation in response to the passage of said front wheel thereover, said plate being defined by a forward edge directed towards said front retaining bracket and an oppositely directed rear edge;
a frame hinged from sad rear edge of said plate and restrained in the pivotal motion about the hinge to a pivotal arc substantially above the upper surface of said plate; and
a spring loaded actuator connected at one end thereof to the free end of said frame and at the other end thereof to a releasable engagement on said ramp spaced rearwardly from the free end of said frame by a dimension compressing the extended length of said actuator, whereby said actuator is released from the compressed state upon the pivotal articulation of said plate to lift the free end of said frame.

2. Apparatus according to claim 1, wherein:
said free end of said frame includes a transverse roller.

3. Apparatus according to claim 2, further comprising:
an articulation lever selectively attachable to said releasable engagement for effecting the release thereof.

4. Apparatus according to claim 1, further comprising:
a rear retaining bracket selectively securable to said ramp proximate the rear end thereof for retaining the rear wheel of said motorcycle.

5. Apparatus according to claim 4, wherein:
said free end of said frame includes a transverse roller.

6. Apparatus according to claim 5, further comprising:
an articulation lever selectively attachable to said releasable engagement for effecting the release thereof.

7. Apparatus for restraining a motorcycle on an articulated ramp deployed from a carrier vehicle to rest on the local ground surface and thereafter raised for transport, comprising:
a front retaining bracket mounted generally orthogonally to the forward end of said ramp to deploy an elevated receiving slip conformed to engage a first wheel of said motorcycle;
an elongate plate defined by a front and a rear edge and provided with a transverse pivot therebetween extending across said ramp, said front edge being spaced proximately adjacent said front retaining bracket to effect pivotal articulation about said transverse pivot in response to the passage of said first wheel thereover;
a frame hinged from sad rear edge of said plate having the pivotal motion about the hinge to a pivotal arc substantially above said plate; and
a spring loaded actuator connected at one end thereof to the free end of said frame and at the other end thereof to a releasable engagement on said ramp spaced rearwardly from the free end of said frame by a dimension compressing the extended length of said actuator.

8. Apparatus according to claim 7, wherein:
said free end of said frame includes a transverse roller.

9. Apparatus according to claim 8, further comprising:
an articulation lever selectively attachable to said releasable engagement for effecting the release thereof upon the release of said actuator from its compressed state by the pivotal articulation of said plate to lift the free end of said frame in response to the passage of said first wheel thereover.

10. Apparatus according to claim 7, further comprising:
a rear retaining bracket selectively securable to said ramp proximate the rear end thereof for retaining the second wheel of said motorcycle upon the release of said actuator from its compressed state by the pivotal articulation of said plate to lift the free end of said frame in response to the passage of said first wheel thereover.

11. Apparatus according to claim 10, wherein:
said free end of said frame includes a transverse roller.

12. Apparatus according to claim 10, further comprising:
an articulation lever selectively attachable to said releasable engagement for effecting the release thereof.

13. An over-center spring loaded mechanism for effecting a self-triggered restraint of a motorcycle wheel against a conforming wheelstop upon the rolling translation thereof towards the forward end of a ramp, comprising:
an elongate plate mounted on a transverse pivot extending across said ramp proximate said wheelstop for pivotal articulation in response to the passage of said wheel thereover, said plate being defined by a forward edge directed towards said wheelstop and an oppositely directed rear edge;
a frame hinged from sad rear edge of said plate and restrained in the pivotal motion about the hinge to a pivotal arc substantially above the upper surface of said plate, the free end of said frame including a transverse roller ; and
a spring loaded actuator connected at one end thereof to the free end of said frame and at the other end thereof to a releasable engagement on said ramp spaced rearwardly from the free end of said frame by a dimension compressing the extended length of said actuator, whereby said actuator is released from the compressed state upon the pivotal articulation of said plate to lift the free end of said frame.

14. Apparatus according to claim 13, further comprising:
a rear retaining bracket selectively securable to said ramp proximate the rear end thereof for retaining the second wheel of said motorcycle upon the release of said actuator from its compressed state by the pivotal articulation of said plate.

15. Apparatus according to claim 14, further comprising:
an articulation lever selectively attachable to said releasable engagement for effecting the release thereof.
